(19) United States
(12) Patent Application Publication
(10) Pub. No.: US 2017/0027133 A1
(43) Pub. Date: Feb. 2, 2017

(54) Adaptive Learning System for Animals

(71) Applicants: Erick Eidus, Kirkland, WA (US); Kandarp Jani, Bellevue, WA (US)

(72) Inventors: Erick Eidus, Kirkland, WA (US); Kandarp Jani, Bellevue, WA (US)

(21) Appl. No.: 14/815,897

(22) Filed: Jul. 31, 2015

(51) Int. Cl. A01K 15/02; A01K 29/00

(52) U.S. Cl. CPC A01K 15/021; A01K 29/005; A01K 15/025

(57) ABSTRACT

In one embodiment, a gaming system may allow pets to engage in games, exercises, training, and other activities with little to no human oversight. A pet may initiate game play by triggering a motion sensor or visual detection sensor, for example, and may progress through levels based on its completion of tasks. Humans may also initiate game play, record, and watch a pet's game play remotely, and receive notifications through various multimedia formats. Adaptive Learning System for Animals may include a console that is physically separate from and compatible with third-party products such controllers, pet toys, and reward dispensing units.

### FIELD

This disclosure relates generally to Adaptive Learning System for Animals.

### BACKGROUND

Many people want to build strong, lasting relationships with their pets. Unfortunately, many owners don't have much time to be physically present with their pets because of time spent away at school or work, for example. However, many owners want their pets to develop cognitive, behavioral, and social skills to become healthy, disciplined, and confident animals, for example. Conventional pet games and training products require a significant amount of human oversight and don't facilitate the independent learning and development of pets.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, Adaptive Learning System for Animals. In one embodiment, it may comprise a gaming system which may allow pets to engage in games, exercises, training, and other activities with little to no human oversight. A pet may initiate game play by performing an action such as pressing a button, touching a toy, picking up a toy, or triggering a motion sensor or visual detection sensor, for example. Game play may also be initiated automatically based on time or a system event, or it may be initiated remotely, for example, by a human using a computer user interface, browser or mobile application. A pet may progress through stages of a game based on its successful completion of various tasks. Adaptive Learning System for Animals may direct a pet to repeat a task or stage if the pet fails or struggles to complete a task, for example. Adaptive Learning System for Animals may recommend, personalize, and modify games based on the age, breed, personality, or other characteristics of a pet.

Adaptive Learning System for Animals may include a console that is physically separate from and compatible with third-party products such as game controllers, pet toys, and reward dispensing units, for example. Humans may also initiate a pet's game play, record and watch game play, and otherwise participate remotely through a computer or mobile device, for example. Humans may receive notifications about a pet's progress through messages, email, photos, video clips, and other multimedia formats, and data may be shared through social media and other outlets.

Adaptive Learning System for Animals may use operant conditioning, whereby a pet may learn to associate a given voluntary behavior with a given consequence. For operant conditioning to be successful, the timing of the association between the voluntary behavior and the given consequence may be critical. Human involvement typically produces delays and judgment, thereby reducing conditioning success. Adaptive Learning System for Animals may reduce the timing to milliseconds and remove human judgment. The use of operant conditioning may also give the pet an intuitive user experience.

Many of the attendant features may be more readily appreciated as they become better understood by reference to the following detailed description considered in connection with the attached drawings.

### BRIEF DESCRIPTION OF THE DRAWINGS

FIG. 1 illustrates an Adaptive Learning System for Animals system, according to one embodiment.

FIG. 2 illustrates a flow diagram of an Adaptive Learning System for Animals process, according to one embodiment.

FIG. 3 illustrates a flow diagram of an Adaptive Learning System for Animals herding game process, according to one embodiment.

FIG. 4 is a block diagram illustrating an example of a system capable of supporting an Adaptive Learning System for Animals, according to one embodiment.

FIG. 5 is a component diagram of a computing device to which an Adaptive Learning System for Animals may be applied according to one embodiment.

Like reference numerals are used to designate like parts in the accompanying drawings.

### DETAILED DESCRIPTION

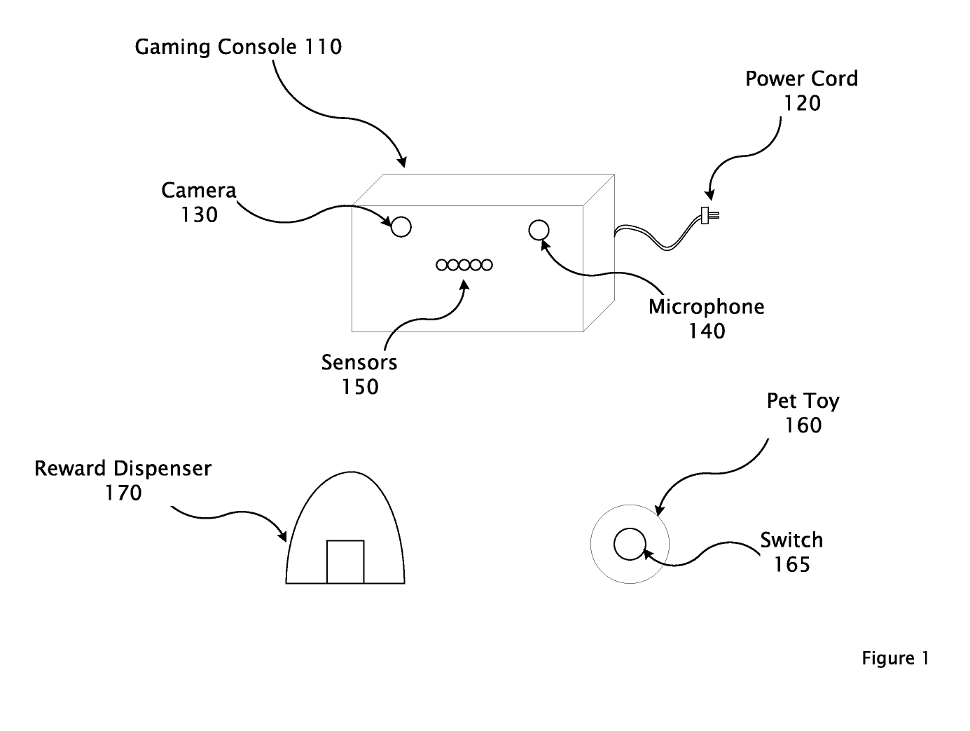

FIG. 1 illustrates Adaptive Learning System for Animals, according to one embodiment. In this example, it may comprise a gaming system which allows pets to engage in games, exercises, training, and other activities with little to no human oversight. Gaming Console 110 may comprise a controlling unit with one or more interfaces, for example, a Bluetooth Low Energy (BLE) interface, a Wi-Fi interface, and a Radio Frequency (RF) interface. Gaming Console 110 may receive power through an electronic Power Cord 120, for example, or other means. One having skill in the art will recognize that other power sources, such as batteries, may be used. Gaming Console 110 may include lights to indicate status, for example. Gaming Console 110 may include or couple to a Camera 130, which may capture still images, video images, infrared heat signatures, and other data. Gaming Console 110 may include or couple to a Microphone 140, which may detect sounds which may be used to distinguish whether a pet has initiated game play or to identify or distinguish a pet, for example. Gaming Console 110 may also include or couple to a plurality of Sensors 150, including, for example, an accelerometer, proximity sensor, motion sensor, touch sensor, pressure sensor, and biometric sensor. One having skill in the art will recognize that other sensors may be used. A biometric sensor may measure and analyze physical characteristics of a pet, for example, it may recognize a dog by size or color. The biometric sensor may also recognize facial patterns (facial recognition), voice patterns, retina or iris patterns, paw prints, or DNA, for example, for authentication purposes or to personalize game play, for example. Gaming Console 110 may be physically separate from and compatible with various third-party products such as game controllers, pet toys, and reward dispensing units, for example.

Gaming Console 110 may communicate with Pet Toy 160. Pet Toy 160 may include a plurality of electronics such as a camera, microphone, speakers, lights such as light-emitting diodes (LEDs), and sensors such as an inductance sensor, accelerometer, motion detection sensor, proximity sensor, touch sensor, moisture sensor, radio-frequency identification (RFID), and a physical switch to detect a moving part, for example. Adaptive Learning System for Animals may include an actuator or other mechanical components which may allow the toy to move, vibrate, or generate a sound. Adaptive Learning System for Animals may also include near-field communication (NFC) technology for functions such as tracking the location of items, for example. One having skill in the art will recognize that other sensors may be used. Pet Toy 160 may be a hard or soft toy, for example, and may be configured to protect the internal electronics from damage, and to protect a pet from injury from tampering or ingesting Pet Toy 160 or its components. A human may receive a notification when Pet Toy 160 has been damaged or otherwise compromised, and may automatically receive a new toy in the mail. Adaptive Learning System for Animals may allow a pet to charge a toy on its own by performing an action such as placing the toy on a wireless charging mat, for example. Pet Toy 160 may also report its battery level to Gaming Console 110, which may communicate the battery level to a human.

Adaptive Learning System for Animals may detect a pet's actions or lack of actions. For example, a sensor may not detect an expected action, and the lack of action may also have an impact on the state of the system. There may be situations wherein the sensors detect an action at the wrong time or at a time that is not intended. This may also have an impact on the state of the system. For example, touching a toy (for example, moving an accelerometer) when a toy is not supposed to be touched, may delay a pet's ability to earn a reward.

Upon the completion of certain actions or lack of actions, a pet may receive rewards from Reward Dispenser 170, which may be any third-party dispenser, for example. Reward Dispenser 170 may dispense food, toys, smells, sounds, images, and tactile sensations, or other rewards, for example. Smells may be dispensed in the form of liquids, gasses, or bubbles, for example, and tactile sensations may include, for example, petting and massages. Rewards may be dispensed automatically, without any human intervention, or they may be dispensed with human intervention; for example, by the pressing of a remote control button.

Adaptive Learning System for Animals may include a Switch 165, such as a large button, which a pet may touch to turn on a device such as Toy 160. In this example, Switch 165 may need to be held down for several seconds to turn off Toy 160, for example, five seconds, but may be briefly touched to turn Toy 160 on. This may allow a human to turn off the device but to prevent a pet from turning it off by accident, for example. Switch 165 configuration may be controlled by software.

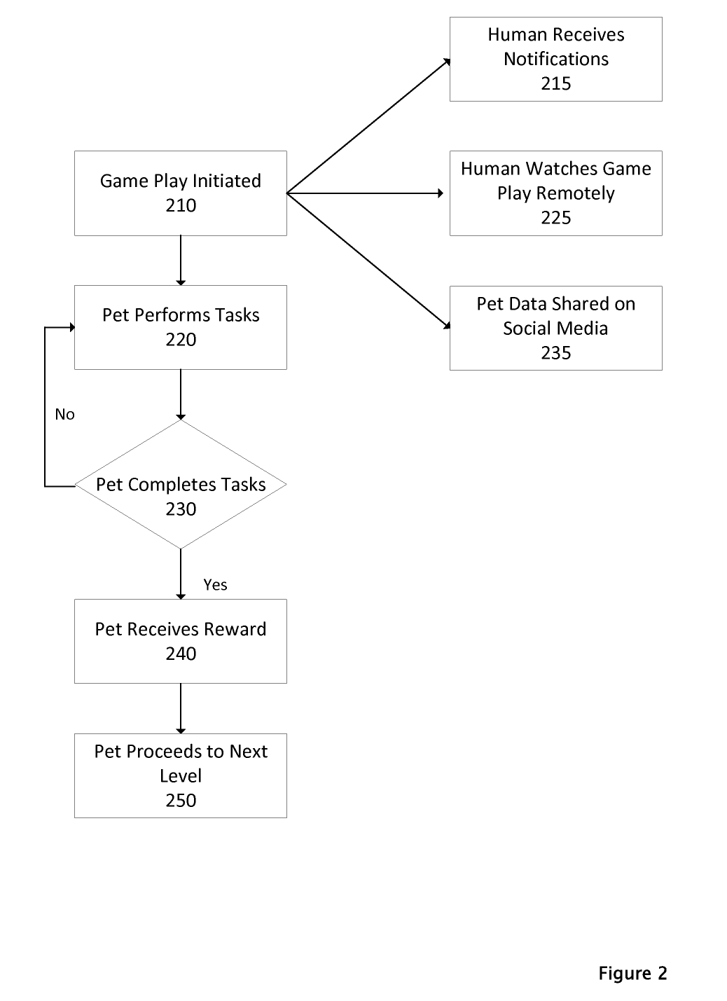

FIG. 2 illustrates a flow diagram of an Adaptive Learning System for Animals process, according to one embodiment. At Game Play Initiated 210, a pet may initiate game play by performing an action such as pressing a button, picking up a toy, or triggering a motion sensor or visual detection sensor, for example. Game play may also be initiated automatically based on time or a system event, or it may be initiated remotely, for example, by a human using a computer user interface, browser or mobile application. At Pet Performs Tasks 220, the pet may progress through game levels based on completion of various tasks. If Pet Completes Tasks 230, the pet may move on to Pet Receives Reward 240. The pet may complete a task and receive rewards many times before moving on to another level. At any stage during an Adaptive Learning System for Animals process, a software program may determine whether the pet has successfully completed a task and whether it should proceed to a different level based on past performance, for example. A human may also send commands to Gaming Console 110 to influence which task the pet has to complete. If not Pet Completes Tasks 230, the pet may be redirected back to Pet Performs Tasks 220. The pet may be directed to a previous level if it fails to complete certain tasks if Adaptive Learning System for Animals system has determined that a pet is struggling at a task or level, for example. A pet may also be directed to jump or skip to higher levels. At Pet Proceeds to Next Level 250, the pet may begin a new level, which may include more advanced or challenging tasks, or simply a different task which is not necessarily more challenging, for example. The pet may receive additional rewards for completing a level, or it may receive rewards only upon completing all levels in a game, for example. Adaptive Learning System for Animals may recommend, personalize, and modify games based on the age, breed, personality, and other characteristics of a pet.

In one embodiment, a pet may be penalized for triggering a sensor at an incorrect time. Such penalty may not be a punishment for the pet, but may delay an opportunity to move forward to Pet Receives Reward 240, for example. At Pet Performs Tasks 220, the absence of detecting a sensor event when one is expected may have an impact on the task that is waiting to be performed. Regarding Pet Completes Tasks 230, the progression through tasks may not be linear. There may be a plurality of tasks that a pet may perform, and the system may reward the pet for performing any of the potentially correct tasks.

Humans may have the ability to kick off Game Play Initiated 210. At Human Receives Notifications 215, a human may receive notifications about a pet's progress through SMS messages, email, photos, video clips, or other multimedia formats, for example. At Human Watches Game Play Remotely 225, humans may view still, video, statistics, and other data, as well as hear sounds from the pet's game play, remotely through a computer or mobile device, for example. Multiple humans may simultaneously participate in Human Watches Game Play Remotely 225. Humans may also interact during Human Watches Game Play Remotely 225; for example, they may engage in direct messaging. Human Watches Game Play Remotely 225 may not be dependent on Human Receives Notifications 215. For example, a human may just open an app and watch a live feed or recorded video without first being notified. At Pet Data Shared on Social Media 235, humans may share data through social media, SMS messages, email, or other channels, or data may be automatically shared by Adaptive Learning System for Animals through any channels available.

Adaptive Learning System for Animals may also be used by multiple pets. Moreover, multiple humans may simultaneously experience the steps Human Receives Notifications 215, Human Watches Game Play Remotely 225, and Pet Data Shared on Social Media 230. Also, humans may be able to partake in other software features such as donating to shelters and adopting pets, for example.

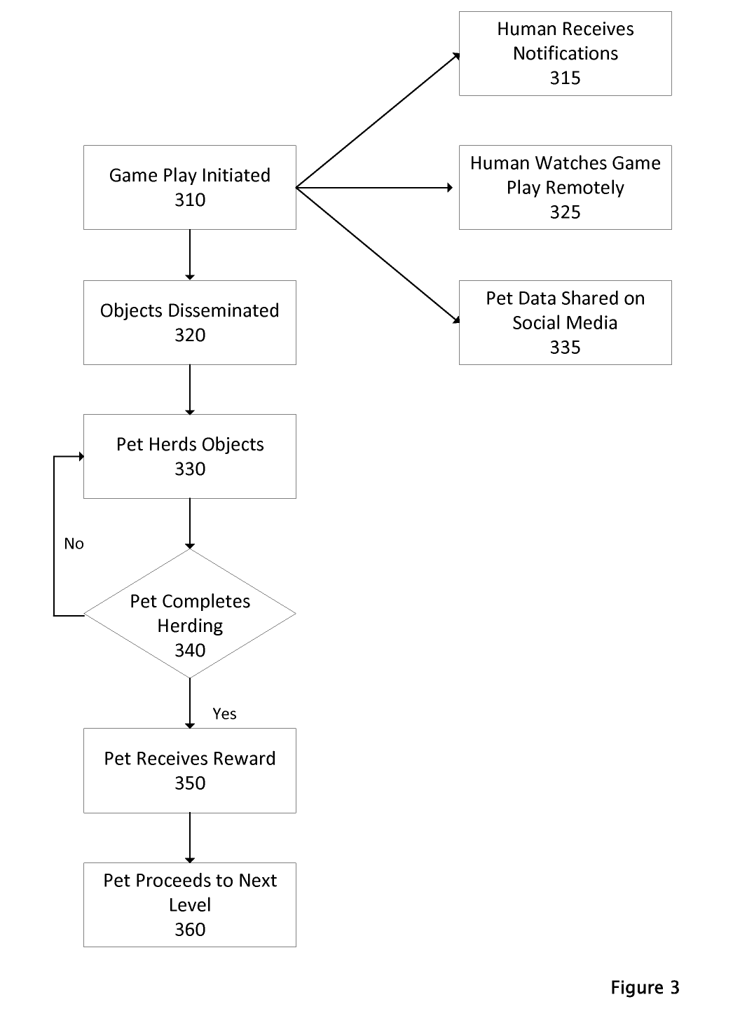

FIG. 3 illustrates a flow diagram of an Adaptive Learning System for Animals herding game process, according to one embodiment. In this example, a herding game may require a pet to herd a plurality of objects. At Game Play Initiated 310, a pet may initiate game play by performing an action such as pressing a button, picking up a toy, or triggering a motion sensor or visual detection sensor, for example. Game play may also be initiated automatically based on time or a system event, or it may be initiated remotely, for example, by a human using a computer user interface, browser or mobile application. At Objects Disseminated 320, a plurality of objects such as pet toys, for example, may either be dispensed and arranged onto a surface by the Adaptive Learning System for Animals system, or the objects may be provided and arranged manually by a human or pet, for example. At Pet Herds Objects 330, a pet may be prompted to lead the objects to a particular location or into a particular formation, for example. At Pet Completes Herding 340, the pet may receive a reward for finishing the required herding actions. At Pet Receives Reward 350, the reward in the herding game may comprise a pet's satisfaction in successfully herding the objects rather than a treat from a treat dispenser, for example. The pet may also be rewarded simply by the act of herding, and further rewards, such as a treat from the treat dispenser, may not be required. The herding game may be a long engagement game, requiring hours of a pet's continuous attention. At Pet Proceeds to Next Level 360, the pet's completion of herding actions may allow it to move onto another level.

In one embodiment, an Adaptive Learning System for Animals herding game may use technology to detect spatial relations between objects. Objects may talk to one another, and their relative positions may be mapped on a mesh network, for example. In another embodiment, a camera in the gaming console may track the objects using infrared or heat detection, for example. In yet another embodiment, a camera in the gaming console may process a particular signal from the objects. In yet another embodiment, a combination of technologies may track the spatial relationship of the objects.

Objects may be configured to wander both away from the herd and in a direction encouraged by a pet. A pet may push or roll the objects, and the pet's location may or may not encourage objects to move in a certain direction. The objects may also have a hierarchy; for example, a lead object may influence the other objects. A pet's ability to determine which object is the leader may impact the behavior of the other objects. Characteristics of an animal herd such as sheep, aligned with a herding animal's natural instinct, may be imitated.

The herding game may become increasingly complex as more objects are added or as the objects become less cooperative and require more aggressive herding or more frequent attention, for example. The behavior of the herd might also evolve to be more complex, with a more complex hierarchy which may make the herd's behavior more complex, such as subgroups that follow different leader objects, for example.

In yet another embodiment, objects in a herding game, such as pet toys, may be aware of one another, such as of their respective location or state. A game might also involve coordination between multiple toys.

At Human Receives Notifications 315, a human may receive notifications about a pet's progress in the herding game through various multimedia formats. At Human Watches Game Play Remotely 325, multiple humans may remotely and simultaneously view still, video, statistics, and other data and sounds from the pet's game play. Humans may also interact during Human Watches Game Play Remotely 325; for example, they may engage in direct messaging. At Pet Data Shared on Social Media 335, humans may share data through social media, SMS messages, email, or other channels, or data may be automatically shared by Adaptive Learning System for Animals through any channels available.

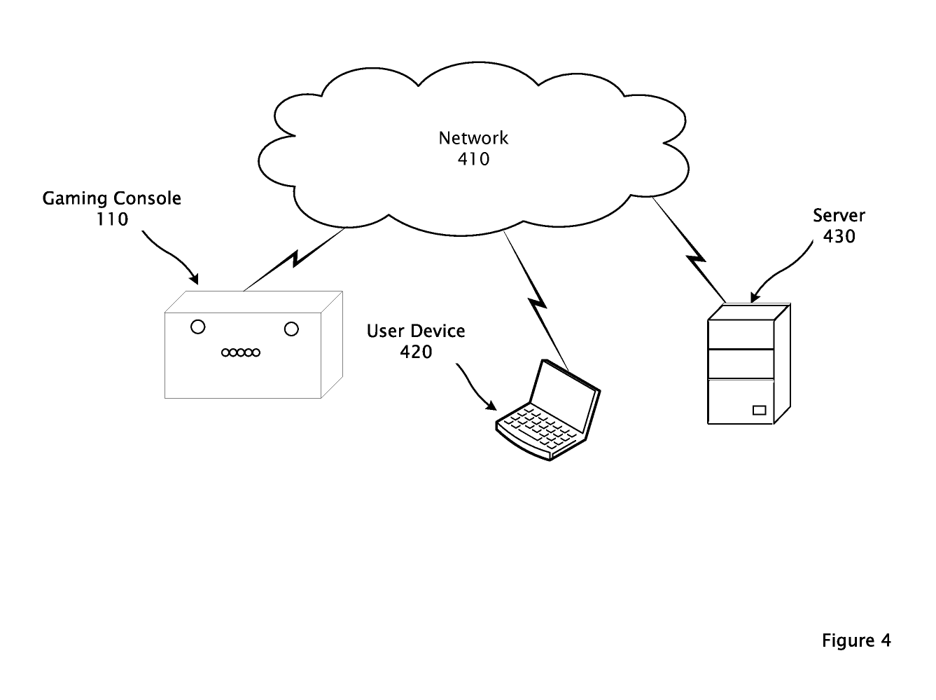

FIG. 4 is a block diagram illustrating an example of a system capable of supporting an Adaptive Learning System for Animals process, according to one embodiment. Network 410 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 410 may comprise Ethernet connectivity. In another embodiment, Network 410 may comprise fiber optic connections.

User Device 420 may be a smartphone, tablet, desktop computer, laptop computer, smart watch or intelligent eyewear, or other device, and may have network capabilities to communicate with Server 430. Server 430 may include one or more computers, and may serve a number of roles. Server 430 may be conventionally constructed or may be of a special purpose design for processing data obtained from Adaptive Learning System for Animals. One skilled in the art will recognize that Server 430 may be of many different designs and may have different capabilities.

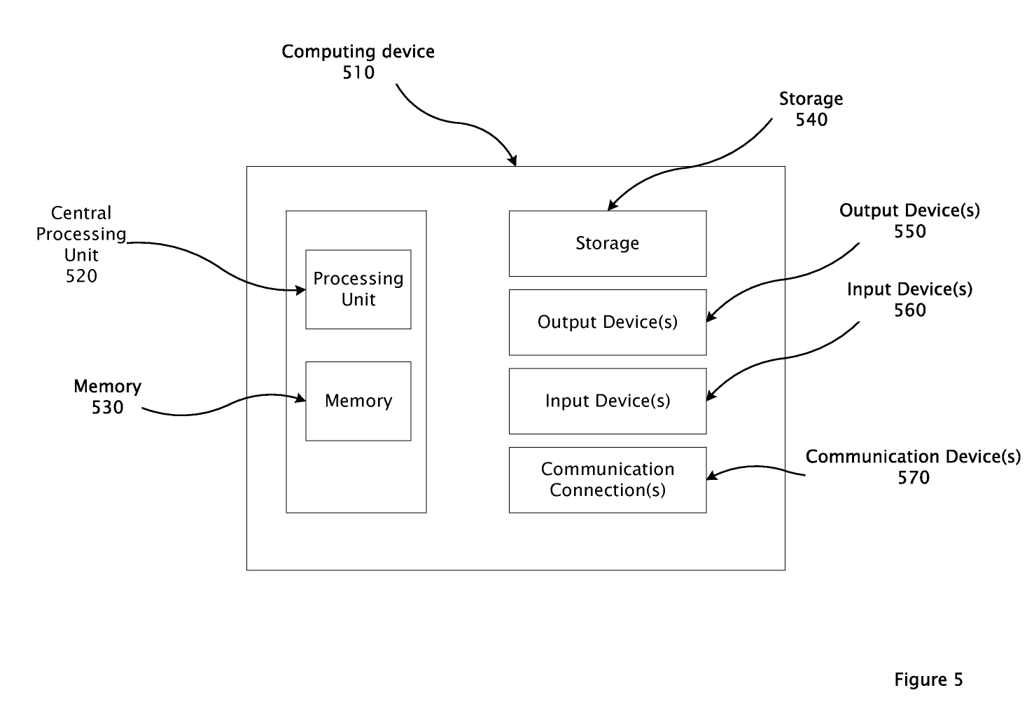

FIG. 5 is a component diagram of a computing device to which an Adaptive Learning System for Animals process may be applied according to one embodiment. The Computing Device 510 can be utilized to implement one or more computing devices, computer processes, or software modules described herein, including, for example, but not limited to a mobile device. In one example, the Computing Device 510 can be used to process calculations, execute instructions, and receive and transmit digital signals. In another example, the Computing Device 510 can be utilized to process calculations, execute instructions, receive and transmit digital signals, receive and transmit search queries and hypertext, and compile computer code suitable for a mobile device. The Computing Device 510 can be any general or special purpose computer now known or to become known capable of performing the steps and/or performing the functions described herein, either in software, hardware, firmware, or a combination thereof.

In its most basic configuration, Computing Device 510 typically includes at least one Central Processing Unit (CPU) 520 and Memory 530. Depending on the exact configuration and type of Computing Device 510, Memory 530 may be volatile (such as RAM), non-volatile (such as ROM, flash memory, etc.) or some combination of the two. Additionally, Computing Device 510 may also have additional features/functionality. For example, Computing Device 510 may include multiple CPUs. The described methods may be executed in any manner by any processing unit in Computing Device 510. For example, the described process may be executed by both multiple CPUs in parallel.

Computing Device 510 may also include additional storage (removable or non-removable) including, but not limited to, magnetic or optical disks or tape. Such additional storage is illustrated in FIG. 4 by Storage 540. Computer readable storage media include volatile and nonvolatile, removable and non-removable media implemented in any method or technology for storage of information such as computer-readable instructions, data structures, program modules or other data. Memory 530 and Storage 540 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 510. Any such computer-readable storage media may be part of Computing Device 510. But computer readable storage media do not include transient signals.

Computing Device 510 may also contain Communications Device(s) 570 that allow the device to communicate with other devices. Communications Device(s) 570 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 510 may also have Input Device(s) 560 such as keyboard, mouse, pen, voice input device, touch input device, etc. Output Device(s) 550 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions, may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. An adaptive game system for pets, comprising:
a gaming console;
a sensor;
a microphone;
a camera;
a controller;
a pet toy; the pet toy comprising a sensor; and
a reward dispenser unit.

2. The adaptive game system for pets of claim 1, further comprising an interface from the list containing Bluetooth Low Energy interface, Wi-Fi interface, and a Radio Frequency interface.

3. The adaptive game system for pets of claim 1, further comprising a wireless charging unit.

4. The sensors of claim 1, further comprising at least one sensor from the list containing accelerometer, proximity sensor, motion sensor, pressure sensor, and biometric sensor.

5. The camera of claim 1, further comprising a still image camera.

6. The camera of claim 1, further comprising the ability to capture panoramic digital images.

7. The camera of claim 1, further comprising a video camera.

8. The reward dispenser unit of claim 1, further comprising the ability to dispense food, toys, smells, sounds, images, and tactile sensations.

9. The adaptive game system for pets of claim 1, further comprising a projector capable of displaying holographic images.

10. A method for Adaptive Learning System for Animals, comprising:
initiating game play;
performing tasks related to a level;
receiving a reward; and
changing to a different level after successful completion of a task.

11. The method of claim 10, wherein either a pet or a human may initiate game play.

12. The method of claim 10, wherein the reward comprises a reward from the list containing food, toys, smells, sounds, images, and tactile sensations.

13. The method of claim 10, further comprising sharing a result on a social media outlet.

14. The method of claim 13, wherein the result shared is displayed in a format from the list containing game statistics, a dashboard, graphs, charts, and multimedia video and images.

15. The method of claim 10, further comprising sending a result to a person via email.

16. Computer readable storage media containing instructions thereon which, when executed by a processor, perform a method comprising:
initiating game play;
performing a task;
receiving a reward; and
being redirected to a second task upon successful completion of a task.
